(19) United States
(12) Patent Application Publication
(10) Pub. No.: US 2021/0051213 A1
(43) Pub. Date: Feb. 18, 2021

(54) NETWORK SERVICES CONTROLLER FOR CLOUD-BASED CONTROL OF CONNECTIVITY FOR HETEROGENEOUS NETWORK INFRASTRUCTURE

(71) Applicant: NEUTRINO8, INC., Santa Clara, CA (US)

(72) Inventor: Bojan Likar, Cupertino, CA (US)

(21) Appl. No.: 16/542,646

(22) Filed: Aug. 16, 2019

(51) Int. Cl. H04L 29/08; H04L 12/725; H04L 12/715; H04L 12/26

(52) U.S. Cl. CPC H04L 67/327; H04L 45/306; H04L 67/16; H04L 43/04; H04L 43/062; H04L 45/64

(57) ABSTRACT

Local runtime data is collected from the plurality of network devices using SDN (software-defined networking). The local runtime data is parsed and sent to an identified microservice for processing. The microservice applies the local runtime data to a set of rules to determine an action to be performed at a specific network device. An SDN controller can initiate and confirm execution of the action at the specific network device through a command to a specific SDN agent.

### FIELD OF THE INVENTION

The invention relates generally to a computerized networking system, and more specifically, for cloud-based control of heterogeneous network components with vendor-agnostic micro-apps analyzing data collected from the heterogenous network components.

### BACKGROUND

Many home and businesses maintain a wireless data network for wireless devices. The network can be implemented by network devices such as routers, access points, gateways, firewalls, and the like. Currently, entities buy network devices from the same vendors in order to collect information and control network services centrally.

However, entities may prefer network devices made by many different vendors and, often, are not inherently interoperable. This make it difficult to collect information and provide responsive services for networks devices, independent of manufacturer. Furthermore, configuration for these tasks difficult.

What is needed is a robust technique for providing vendor-agnostic data collection and network services responsive to the data collection (e.g., configuration, monitoring, alarms, accounting data, and the like) for heterogenous network infrastructure components.

### SUMMARY

The above-mentioned needs are met with methods, computer products, and devices for a computer-implemented method for providing vendor-agnostic data collection and network services responsive to the data collection for heterogenous network infrastructure components.

In one embodiment, an SDN (software-defined networking) controller running on a processor of the cloud-based gateway, registers microservices available to the network. Also, the SDN controller registers a plurality of SDN agents installed within the plurality of network devices and located remotely on the data communication system from the cloud-based gateway. Specific local configuration data collected by a specific SDN agent locally at the network device can be received and a microservice appropriate based on the specific local configuration data is identified. The identified microservice is then associated with the specific SDN agent.

Local runtime data is collected from the plurality of network devices. The local runtime data is parsed and sent to the identified microservice for processing. The microservice applies the local runtime data to a set of rules to determine an action to be performed at a specific network device. The SDN controller can initiate and confirm execution of the action at the specific network device through a command to the specific SDN agent.

Advantageously, performance of network devices is improved with dynamic adjustments to heterogeneous network architectures.

### BRIEF DESCRIPTION OF THE DRAWINGS

In the following drawings, like reference numbers are used to refer to like elements. Although the following figures depict various examples of the invention, the invention is not limited to the examples depicted in the figures.

FIGS. 1A & 1B is a high-level block diagram illustrating a system for providing vendor-agnostic data collection and network services responsive to the data collection for heterogenous network infrastructure components, according to an embodiment.

FIG. 2 is a more detailed block diagram illustrating a cloud-based Wi-Fi gateway of the system of FIG. 1, according to one embodiment.

FIG. 3 is a more detailed block diagram illustrating the network device of the system in FIG. 1, according to one embodiment.

FIG. 4 is a high-level flow diagram illustrating a method for providing vendor-agnostic data collection and network services responsive to the data collection for heterogenous network infrastructure components, according to one embodiment.

FIG. 5 is a block diagram illustrating an exemplary computing device for implementing the techniques described herein, according to one embodiment.

### DETAILED DESCRIPTION

Methods, (non-transitory) computer program products, and systems for plug-and-play configuration for providing vendor-agnostic network service to heterogenous network infrastructure components, as described herein. As used herein, onboarding refers to registering network devices for cloud configuration. One of ordinary skill in the art will recognize variations to the disclosed embodiments that are contemplated, although not explicitly described.

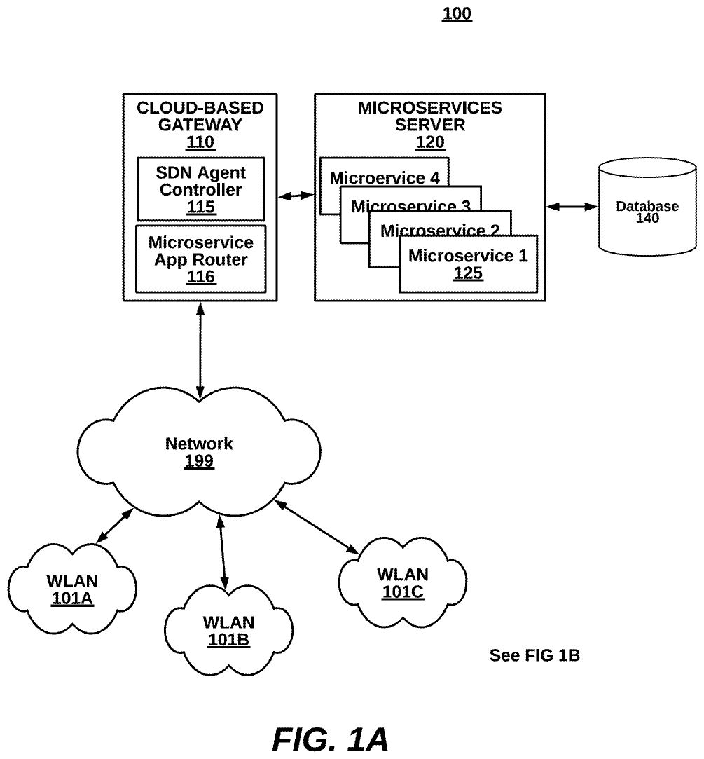

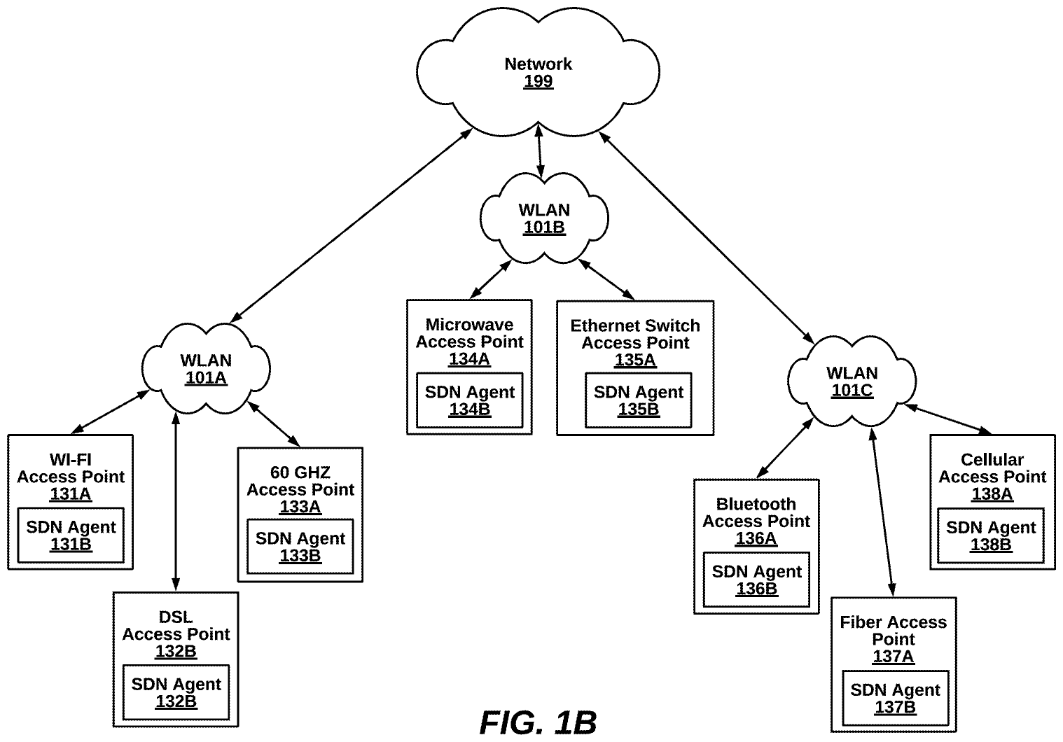

I. Systems for Providing Vendor-Agnostic Micro-Services to Heterogenous Network Components (FIGS. 1-3)

FIGS. 1A & 1B a high-level block diagram illustrating a system 100 for plug-and-play configuration for providing vendor-agnostic data collection and network services responsive to the data collection for heterogenous network infrastructure components, according to an embodiment.

The system 100 comprises a cloud-based Wi-Fi gateway 110, a microservices server 120, and heterogenous network devices 131A-138A, in various configurations. In other embodiments of the system 100, additional network components can also be part of the systems, such as firewalls, virus scanners, routers, switches, application servers, databases, as well as additional controllers, access points, access switches, stations, and the like. The network components as set forth throughout the different embodiments described herein can be implemented as hardware, software, or a combination of both. The system 100 can be implemented in home networking systems with easy consumer set-up. Also, system 100 can be implemented in enterprise networking systems for quick deployment without the need for a network administrator.

The components of the system 100 can communicate by transmitting data through a network 199 and WLANs 101A-101C. More specifically, the network 199 couples the cloud-based gateway 110 to the microservices server 120 and to WLANs 101A-101C, preferably over a wired connection. In turn, the WLANs 101A-101C couple to heterogeneous network devices 131A-138A through wired or wireless connections. The networks 199 and 101A-101C can be the Internet, a wide area network, a local area network, an enterprise network, or the like. The network 199 can be a data network or a cellular network (e.g., 3G, 4G or 5G), or a combination of different types of networks. Downstream networks can be Wi-Fi, millimeter, microwave, fiber or other wiring, Bluetooth, mesh, or any combination of network protocols and communication mediums. In one embodiment, network 199 is the Internet and WLANs 101A-101C are separately controlled entities. For example, the cloud-based gateway 110 can be a third-party controlled software as a service providing cloud-services to three different corporate customers controlling 101A, 101B and 101C, respectively.

The cloud-based Wi-Fi gateway 110 routes data collected from the heterogeneous network devices to specific micro-services for analyzing the data or for storing in a database. Before collecting data, the heterogeneous network devices 131-134 are configured to allow data collection and are registered with the cloud-based Wi-Fi gateway 110. Real-time data analysis can lead to an action on the heterogeneous network devices 130 responsive to the collected data. For example, a set of business rules configured by a user or a network administrator can be executed responsive to data collected. More specifically, an energy saver app on the cloud-based Wi-Fi gateway 110 may warn a user on power wasted by leaving a Samsung PC monitor on overnight. Many other responsive action are possible, based on the microservices.

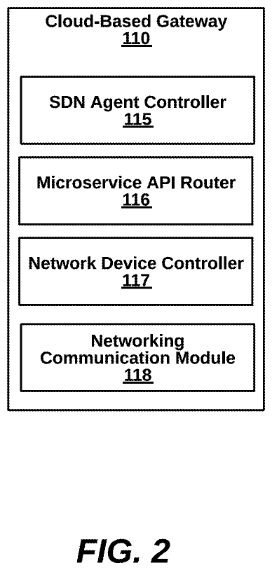

The cloud-based gateway 110 and other components of the system 100 can be any computerized device or processor driven device. Example embodiments include server blades, desktop computers, laptops, smart telephones, tablets, phablets and the like. In some cases, the cloud-based gateway 110 is operated by a service provider that services various user accounts for different users. In other cases, the cloud-based gateway 110 is owned by the same entity the owns associated access points. The cloud-based gateway 110 can be the same entity that manufactures the new device 120, or not. In various implementations, a separate configuration server, or separate processes within a common server, handle other configurations processes after initial onboarding. More detailed embodiments of the cloud-based gateway 110 are set forth below with respect to FIG. 2.

The heterogeneous network devices 131 of this particular system include Wi-Fi access point 131A, DSL access point 132A, 60 GHz access point 133A, microwave access point 134A, Ethernet switch access point 135A, Bluetooth access point 136A, fiber access point 137A, and cellular access points 138A (3G, 4G or 5G), but can also include, gateways, firewalls, laptops, mobile stations, network appliances, or the like. In some cases, one network devices access the data communication network through another network device (e.g., a mesh network, or a mobile station utilizing an access point). The network devices can be produced by various vendors such as Fortinet, Inc., Cisco Systems, Aruba Networks, and others. Network appliances (e.g., connected washing machines and connected refrigerators) can be produced by General Electric, Kenmore, Whirlpool, and others. Various types of communication technologies can be implemented, such as different versions of Wi-Fi, Bluetooth, microwave, and the like. Typically, vendors also have private and non-standardized mechanisms for sending control information between network devices.

In one embodiment, the network devices 131A-138A include SDN agents 131B-138B installed as software. An SDN agent, being local and hooked into the operating system, can download specific drivers and patches needed for compatibility with local hardware and software. OpenFlow or another vendor-independent protocol is utilized for communication. As a result, network devices produced by different vendors can be configured centrally, regardless of the vendor. For example, an SDN agent can check records in the operating system for identification of hardware on a PC. Information for a NIC card, along with a MAC address, driver version, and supporting software can all be collected and sent upstream to the cloud-based gateway 110. Additional information can include performance metrics for network processors on the NIC card, cache storage and traffic throughput. Environmental conditions such as on-board temperature and ambient temperature and humidity can also be collected and reported. A microservice may determine that the NIC card configurations need updating or that a different channel should be used.

There can many different types of microservices, depending on specific implementations. Microservices are relatively small software applications with a very specific functionality as an alternative to a single, monolithic application. Additionally, microservices allow complete virtualization of networking elements from various technologies.

As previously discussed, node configuration is one example of a microservice. Heterogeneous devices can be configured for a common service, for increased network loads, for new operating systems, or changes in the network architecture, for instance. A new device can be automatically configured for a VLAN, for authentication, or with certain WDS (wireless distribution system) configuration data. Performance microservices is another example. Each node can send periodic performance reports to the cloud, routed by the cloud-based gateway 110 and property stored in the database 140. User microservices can authenticate a user that wants to use certain services. Microservices can later network devices for certain contexts, such as a microservice for coffee shops, a microservice for gas stations, or a microservice specific for municipal government network devices. In some embodiments, local SDN agents assist or enhance microservices during execution, in addition to front end configuration and calls.

FIG. 2 is a more detailed block diagram illustrating the cloud-based gateway 110 of the system 100 of FIG. 1, according to one embodiment. The cloud-based gateway 110 of this embodiment includes an SDN agent controller 115, a microservice API router 116, a network device controller 117, and networking hardware 118.

The SDN agent controller 115 manages the local SDN agents 131B-134B on the network devices that are downstream from the central cloud. Once downloaded locally, an SDN agent can authenticate and register with the cloud-based gateway 110. Also, power ups, power downs, reboots, and online status can affect whether a particular SDN agent is currently active with the SDN agent controller 115.

The microservice API router 116 manages microservices 125 that are internal to the central cloud. More specifically, information received downstream from local network devices can be parsed and then routed to an appropriate microservice 125. Some information is routed to several microservices. One embodiment routes collected data to other external resources, such as a remote microservice server operated by at third-party. The database 140 supports the microservices 120 to store incoming information and processed data.

The network device controller 117 registers devices and communications from a device level of the network architecture. A particular network device can be taken offline or active to be online, for example, apart from particular services of the network device.118

The networking communication module 118 can comprise networking interface components such as Wi-Fi radios, Wi-Fi antennae, transceivers, coders and decoders, digital signal processors, and other supporting lower level hardware and processes necessary for communication across channels. The networking communication module 118 can support different variations of IEEE 802.11, including multiple input/multiple output (MIMO) and other techniques. Returning to the task of sending generated parameters to slave base stations, data packets sent over the data network are received by an interface to a cellular data network (e.g., Verizon 4G cellular data network). A cellular data network including, for example, cell towers pass the data packets to wireless stations.

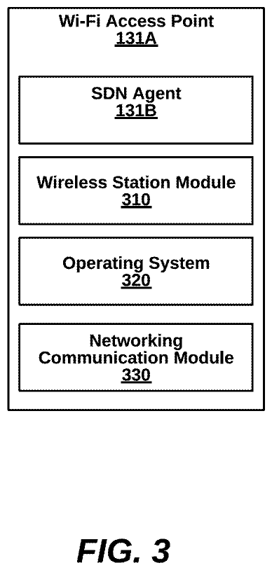

FIG. 3 is a more detailed block diagram illustrating the Wi-Fi access point 131A of the system 100 of FIG. 1, according to one embodiment. The Wi-Fi access point 131A is an example of network devices 131A-138A and includes an SDN agent 131B, a wireless station module 310, an operating system 320 and networking communication module 330.

The SDN agent 131B is in communication with the operating system 320 and the networking communication module 330. This allows the SDN agent 131B to intercept messages between hardware and software and within software process communication with each other (e.g., wireless station module 310). The raw messages can be sent to the cloud-based gateway 110, or the raw messages can be processed, aggregated, or formatted prior to being sent upstream. In one embodiment, information is drawn from the wireless station module 310 for a particular session with a particular station or a particular user, for an appropriate microservice.

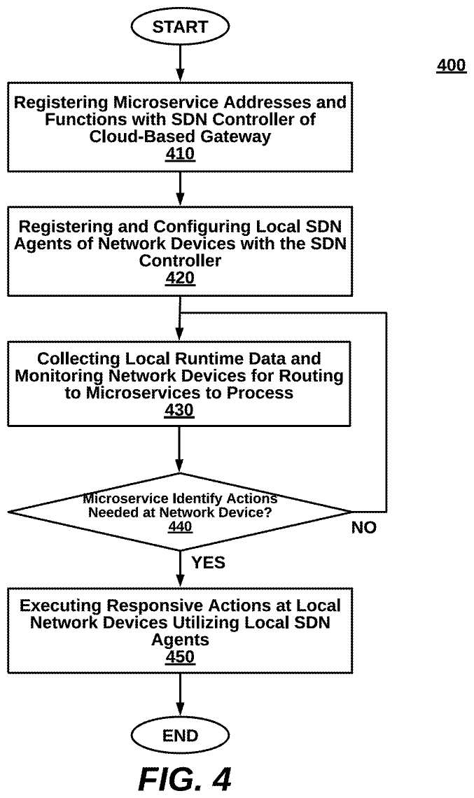

II. Method for Providing Vendor-Agnostic Micro-Services to Heterogenous Network Components (FIGS. 4)

FIG. 4 is a high-level flow diagram illustrating a method 400 for providing vendor-agnostic data collection and network services responsive to the data collection for heterogenous network infrastructure components, according to one embodiment. The method 400 is one example of the operation for the system 100 of FIG. 1 or other systems. In some embodiments, additional steps are performed, and in other embodiments, steps are performed in a different order.

At step 410, microservices are registered with an SDN controller of a cloud-based gateway. The registration can be in batch for several devices, such as in an initial set up. The registration can also be based on a new microservice added to the lineup, or when an existing service is updated and re-registered, for instance.

At step 420, local SDN agents of network devices are registered with an SDN Agent controller 115 of a cloud-based gateway 110. One embodiment assigns a unique identifier to each local SDN agent.

At step 430, local runtime data is collected form SDN agent monitoring at the network devices. The data is received upstream at a gateway and parsed for identifying an appropriate microservice. The table of SDN agents can be updated for particular microservices.

When the microservice identifies a responsive action needed at a network device, at step 440, the SDN controller can help facilitate execution with the local SDN agent.

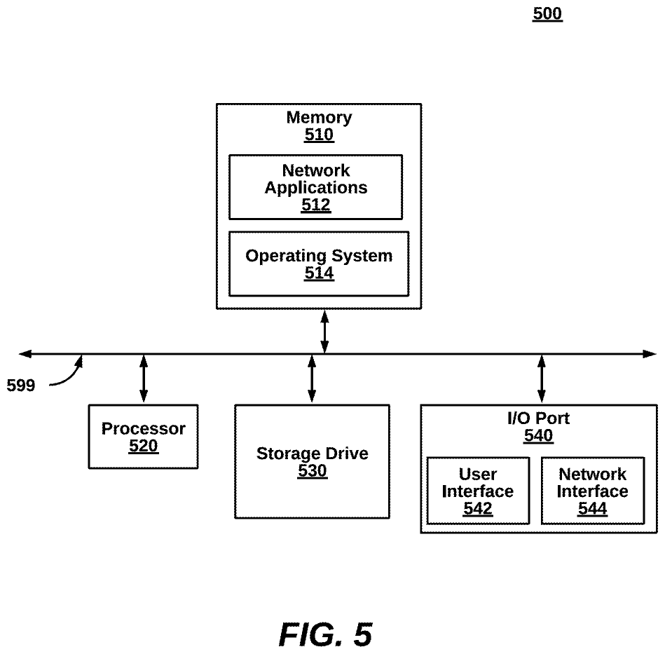

III. Generic Computing Device (FIG. 5)

FIG. 5 is a block diagram illustrating an exemplary computing device 500 for use in the system 100 of FIG. 1, according to one embodiment. The computing device 500 is an exemplary device that is implementable for each of the components of the system 100, including the cloud-based gateway 110, the microservices server 120, and the access points 131A-134A 130. The computing device 500 can be a mobile computing device, a laptop device, a smartphone, a tablet device, a phablet device, a video game console, a personal computing device, a stationary computing device, a server blade, an Internet appliance, a virtual computing device, a distributed computing device, a cloud-based computing device, or any appropriate processor-driven device.

The computing device 500, of the present embodiment, includes a memory 510, a processor 520, a storage drive 530, and an I/O port 540. Each of the components is coupled for electronic communication via a bus 599. Communication can be digital and/or analog, and use any suitable protocol.

The memory 510 further comprises network applications 512 and an operating system 514. The network applications 512 can include the modules of the components illustrated in FIGS. 1. Other network applications 512 can include a web browser, a mobile application, an application that uses networking, a remote application executing locally, a network protocol application, a network management application, a network routing application, or the like.

The operating system 514 can be one of the Microsoft Windows® family of operating systems (e.g., Windows 95, 98, Me, Windows NT, Windows 2000, Windows XP, Windows XP x64 Edition, Windows Vista, Windows CE, Windows Mobile, Windows 8 or Windows 10), Linux, HP-UX, UNIX, Sun OS, Solaris, Mac OS X, Alpha OS, AIX, IRIX32, or IRIX64. Other operating systems may be used. Microsoft Windows is a trademark of Microsoft Corporation.

The processor 520 can be a network processor (e.g., optimized for IEEE 802.11), a general-purpose processor, an application-specific integrated circuit (ASIC), a field programmable gate array (FPGA), a reduced instruction set controller (RISC) processor, an integrated circuit, or the like. Qualcomm Atheros, Broadcom Corporation, and Marvell Semiconductors manufacture processors that are optimized for IEEE 802.11 devices. The processor 520 can be single core, multiple core, or include more than one processing elements. The processor 520 can be disposed on silicon or any other suitable material. The processor 520 can receive and execute instructions and data stored in the memory 510 or the storage drive 530.

The storage drive 530 can be any non-volatile type of storage such as a magnetic disc, EEPROM, Flash, or the like. The storage drive 630 stores code and data for applications.

The I/O port 540 further comprises a user interface 542 and a network interface 544. The user interface 542 can output to a display device and receive input from, for example, a keyboard. The network interface 544 (e.g. RF antennae) connects to a medium such as Ethernet or Wi-Fi for data input and output.

Many of the functionalities described herein can be implemented with computer software, computer hardware, or a combination.

Computer software products (e.g., non-transitory computer products storing source code) may be written in any of various suitable programming languages, such as C, C++, C#, Oracle® Java, JavaScript, PHP, Python, Perl, Ruby, AJAX, and Adobe® Flash®. The computer software product may be an independent application with data input and data display modules. Alternatively, the computer software products may be classes that are instantiated as distributed objects. The computer software products may also be component software such as Java Beans (from Sun Microsystems) or Enterprise Java Beans (EJB from Sun Microsystems).

Furthermore, the computer that is running the previously mentioned computer software may be connected to a network and may interface to other computers using this network. The network may be on an intranet or the Internet, among others. The network may be a wired network (e.g., using copper), telephone network, packet network, an optical network (e.g., using optical fiber), or a wireless network, or any combination of these. For example, data and other information may be passed between the computer and components (or steps) of a system of the invention using a wireless network using a protocol such as Wi-Fi (IEEE standards 802.11, 802.11a, 802.11b, 802.11e, 802.11g, 802.11i, 802.11n, and 802.11ac, 802.11ax, just to name a few examples). For example, signals from a computer may be transferred, at least in part, wirelessly to components or other computers.

In an embodiment, with a Web browser executing on a computer workstation system, a user accesses a system on the World Wide Web (WWW) through a network such as the Internet. The Web browser is used to download web pages or other content in various formats including HTML, XML, text, PDF, and postscript, and may be used to upload information to other parts of the system. The Web browser may use uniform resource identifiers (URLs) to identify resources on the Web and hypertext transfer protocol (HTTP) in transferring files on the Web.

IV. Additional Embodiments

Generally, one of ordinary skill in the art will recognize that the examples set forth herein are non-limiting and only illustrative of widely applicable principles. Accordingly, this description of the invention has been presented for the purposes of illustration and description. It is not intended to be exhaustive or to limit the invention to the precise form described, and many modifications and variations are possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

I claim:

1. A computer-implemented method, in a cloud-based gateway of a data communication system coupled in communication with a plurality of network devices and a microservices server, implemented at least partially in hardware, for providing vendor-agnostic network service to heterogenous network infrastructure components, the method comprising the steps of:
registering, with an SDN (software-defined networking) controller running on a processor of the cloud-based gateway, microservices;
registering, with the SDN controller, a plurality of SDN agents installed within the plurality of network devices and located remotely on the data communication system from the cloud-based gateway;
receiving, through a network interface of the cloud-based gateway, specific local configuration data collected by a specific SDN agent locally at the network device and identifying a microservice appropriate based on the specific local configuration data;
associating, and storing in a memory element of the cloud-based gateway, the identified microservice with the specific SDN agent;
collecting local runtime data from the plurality of network devices;
parsing and routing the local runtime data to the identified microservice for processing, wherein the microservice applies the local runtime data to a set of rules to determine an action to be performed at a specific network device; and
confirming execution of the action at the specific network device through a command to the specific SDN agent.

2. The method of claim 1, wherein the specific SDN agent is associated with more than one microservice.

3. The method of claim 1, wherein the network device comprises at least one of: a Wi-Fi router, an access point, a switch, a bride device, and a network extender device.

4. The method of claim 1, wherein the SDN controller and the SDN agents communicate with OpenFlow.

5. A non-transitory computer-readable media storing source code that, when executed, performs a computer-implemented method in a cloud-based gateway of a data communication system coupled in communication with a plurality of network devices and a microservices server, implemented at least partially in hardware, for providing vendor-agnostic network service to heterogenous network infrastructure components, the method comprising the steps of:
registering, with an SDN (software-defined networking) controller running on a processor of the cloud-based gateway, microservices;
registering, with the SDN controller, a plurality of SDN agents installed within the plurality of network devices and located remotely on the data communication system from the cloud-based gateway;
receiving, through a network interface of the cloud-based gateway, specific local configuration data collected by a specific SDN agent locally at the network device and identifying a microservice appropriate based on the specific local configuration data;
associating, and storing in a memory element of the cloud-based gateway, the identified microservice with the specific SDN agent;
collecting local runtime data from the plurality of network devices;
parsing and routing the local runtime data to the identified microservice for processing, wherein the microservice applies the local runtime data to a set of rules to determine an action to be performed at a specific network device; and
confirming execution of the action at the specific network device through a command to the specific SDN agent.
